(19) United States
(12) Patent Application Publication
(10) Pub. No.: US 2009/0018887 A1
(43) Pub. Date: Jan. 15, 2009

(54) Method of and System for Modifying Attendance Status for Electronic Calendar Events

(76) Inventors: Judith Helen Bank, Morrisville, NC (US); Lisa Marie Wood Bradley, Cary, NC (US); Belinda Ying-Chieh Chang, Cary, NC (US); Tamera L. Davis, Raleigh, NC (US); Lin Sun, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/777,790

(22) Filed: Jul. 13, 2007

(51) Int. Cl. G06Q 10/00; G06F 17/30; G06F 17/40

(52) U.S. Cl. 705/8

(57) ABSTRACT

An electronic calendar system and method permits an attendee of a calendar event to modify the terms of his or her attendance and notifies a requester of the event of the modification of terms of attendance by the attendee. The terms of attendance may include an event start time and an event end time. The system displays to the attendee an attendance modification dialog. The attendance modification dialog may include a late arrival field and an early departure field. The attendance modification dialog may include a telephone attendance option. The attendance modification dialog may be displayed to the attendee in connection with an event invitation, an event reminder, or a calendar event item. When the attendee completes the modification dialog, a message informing to the event requester of the modification is automatically sent.

### BACKGROUND OF THE INVENTION

1. Technical Field

The present invention relates generally to the field of electronic calendaring, and more particularly to a method of and system for allowing an event attendee to modify the terms of his or her attendance at the event and notifying an event requester of a modification of terms of attendance of the attendee at the event.

2. Description of the Related Art

Electronic calendaring systems, such as those provided by Microsoft® Outlook® or Lotus® Notes®, are useful to help individuals and members of organizations manage their time. An electronic calendaring system enables an individual to note and be reminded of appointments and events. Most electronic calendaring systems include a facility that allows a meeting requester or coordinator to schedule a meeting to be attended by members of a group or organization. The calendaring system uses electronic mail invitations to invite individuals to meetings or events. An invitee may either accept or decline the invitation. If the invitee accepts the invitation, the meeting or event is posted to the invitee's calendar. Most calendaring systems include a reminder feature that displays on the screen of the user's computer a note reminding the user of an upcoming meeting.

A user may not be able to attend an entire event. Sometimes, the user may know at the time he or she receives an invitation that he or she will have to arrive late to, or depart early from, the event or that he or she may have to attend by telephone rather than in person. Other times, something may have come up after accepting the invitation but before the event that prevents the user from attending the entire event.

There currently is no efficient way for enabling a user to notify an event requester or coordinator of his or her inability to attend an entire event. The user may call or email the event requester or coordinator, but those methods of notifying the requester or coordinator are not convenient or efficient. A user can change the start or end times on his or her electronic calendar to conform the calendar to his or her anticipated arrival or departure times. However, when a user changes a calendar entry, the requester or coordinator of the event is not notified of the change.

### SUMMARY OF THE INVENTION

The present invention provides an electronic calendar system and method that permits an attendee of said calendar event to modify the terms of his or her attendance of the calendar event and notifies a requester of the event of the modification of terms of attendance by the attendee. The terms of attendance may include an event start time and an event end time. Embodiments of the invention include displaying to the attendee an attendance modification dialog. The attendance modification dialog may include a late arrival field and an early departure field. The attendance modification dialog may also include control that allows the attendee to select whether he or she will attend by phone or in person a meeting that has an assigned conference room. The attendance modification dialog may be displayed to the attendee in connection with an event invitation, an event reminder, or a calendar event item. When the attendee completes the modification dialog, a message informing to the event requester or coordinator of the modification is automatically sent.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is an illustration of a meeting invitation according to an embodiment of the present invention;

FIG. 3 is an illustration of the meeting invitation of FIG. 2 with an acceptance dialog according to an embodiment of the present invention;

FIG. 4 is an illustration of a meeting reminder according to an embodiment of the present invention;

FIG. 5 is an illustration of the meeting reminder of FIG. 4 with a modify dialog according to an embodiment of the present invention;

FIG. 6 is an illustration of a calendar event according to an embodiment of the present invention;

FIG. 7 is an illustration of the calendar event of FIG. 6 with a modify dialog according to an embodiment of the present invention;

FIG. 8 is a flow chart of an embodiment of calendar event invitation processing according to the present invention;

FIG. 9 is a flow chart of an embodiment of modified attendance processing according to the present invention;

FIG. 10 is a flow chart of an embodiment of calendar event reminder processing according to the present invention;

FIG. 11 is a flow chart of an embodiment of calendar item processing according to the present invention; and,

FIG. 12 is a block diagram of an information handling system adapted to embody systems and methods according to the present invention.

### DETAILED DESCRIPTION OF THE PREFERRED EMBODIMENT

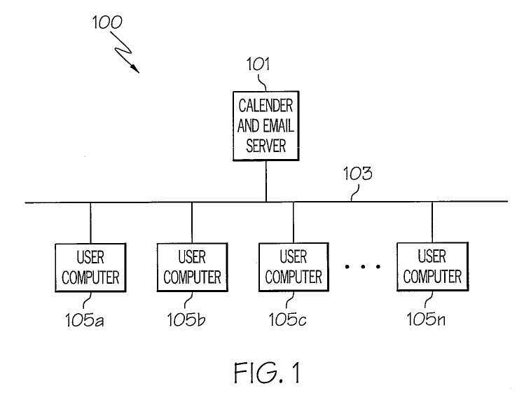

Referring now to the drawings, and first FIG. 1, a system according to the present invention is designated generally by the numeral 100. System 100 includes a calendar and mail server 101 coupled to a network 103. A plurality of user computers 105 are coupled to network 103. Calendar and email server 101 is a computer upon which is installed a calendar and email server applications such as Lotus® Domino® or Microsoft® Exchange®. Each user computer 105 is a computer such as a personal computer, a notebook computer, a workstation, or the like, upon which is installed a calendar and email client application. Network 103 may be of any type, such is a local area network, using any protocol, such as Ethernet.

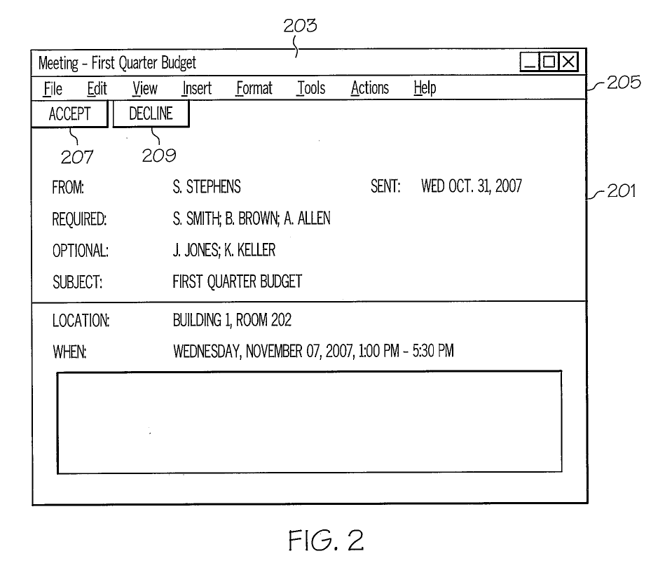

FIG. 2 illustrates an event invitation 201 according to an embodiment of the present invention. Event invitation 201 may be prepared by an event requester using a typical email and calendar application. Event invitation 201 includes the name of requester, the names of the required attendees, the names of any optional attendees, the subject of the event, the location of the event, the date of the event, and the start and stop times for the event. Event invitation 201 may be sent to the required and optional attendees in the form of an email item. Event invitation 201 includes a title bar 203 and an action bar 205. Event invitation 201 also includes an Accept button 207 and a Decline button 209.

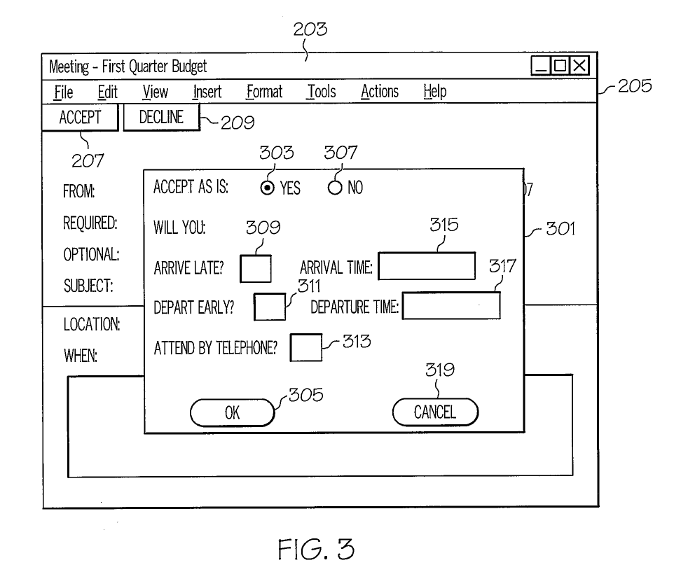

FIG. 3 illustrates event invitation 201 after actuation of Accept button 207. According to the illustrated embodiment the present invention, actuation of Accept button 207 causes the display of an acceptance dialog 301. Acceptance dialog 301 presents various options for accepting the invitation to the event. More specifically, the recipient of invitation 201 is given the option to accept the invitation as is or to modify the terms of his or her acceptance. The recipient may accept the invitation as is by actuating a Yes radio button 303 and an OK button 305. If the recipient desires to modify the terms of his or her acceptance, the recipient actuates a No radio button 307, enters modified terms of acceptance, and actuates OK button 305. When the recipient actuates OK button 305, the system automatically sends an acceptance modification message to the requester of the event. The system may optionally send an acceptance modification message to the other recipients of the invitation.

In the illustrated embodiment, the modifiable terms of acceptance include arrival time, departure time, and the option to attend by telephone rather than in person. Acceptance dialog 301 includes an Arrive late checkbox 309, a Depart early checkbox 311, and an Attend by telephone checkbox 313. As those skilled in the art will recognize, a system according to the present invention my include logic or intelligence whereby if the event is a teleconference, Web conference, or the like, acceptance dialog 301 will not include Attend by telephone checkbox 313. Acceptance dialog 301 includes an arrival time entry field 315 and a departure time entry field 317. The recipient of event invitation 201 may enter his or her anticipated arrival time or departure time into entry field 315 and 317, respectively. Acceptance dialog 301 also includes a Cancel button 319 that allows the recipient to return to event invitation 201 of FIG. 2 without modifying his or her terms of acceptance.

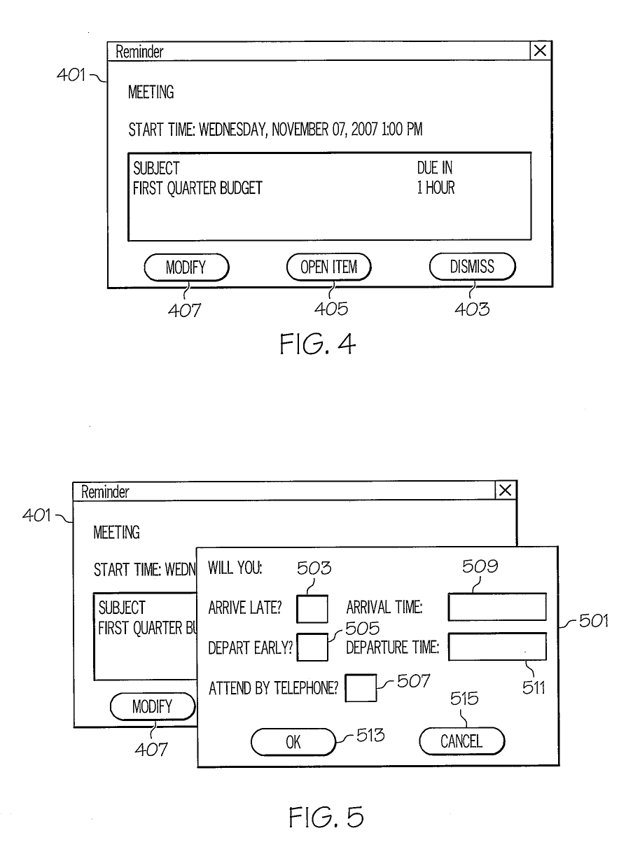

FIG. 4 illustrates an event reminder 401 according to the present invention. As is well known to those skilled in the art, electronic calendar applications typically provide event reminders at times selected by the attendee prior to the event. Event reminder 401 includes a Dismiss button 403 and an Open Item button 405. Actuation of Dismiss button 403 closes event reminder 401. Actuation of Open Item button 405 opens the calendar item underlying the reminder.

According to the present invention, event reminder 401 includes a Modify button 407. As shown in FIG. 5, actuation of Modify button 407 causes the display of an attendance modification dialog 501 that enables a meeting attendee to modify the terms of his or her attendance at the event. Attendance modification dialog 501 includes an Arrive late checkbox 503, a Depart early checkbox 505, and an Attend by telephone checkbox 507. As those skilled in the art will recognize, a system according to the present invention my include logic or intelligence whereby if the event is a teleconference, Web conference, or the like, attendance modification dialog 501 will not include Attend by telephone checkbox 507. Attendance modification dialog 501 includes an arrival time entry field 509 and a departure time entry field 511. The attendee may enter his or her anticipated arrival time or departure time into entry field 509 and 511, respectively. After the attendee has completed attendance modification dialog 501, the attendee can register modified terms of attendance by actuating an OK button 513. Attendance modification dialog 501 also includes a Cancel button 515 that allows the attendee to return to event reminder 401 of FIG. 4 without modifying his or her terms of attendance.

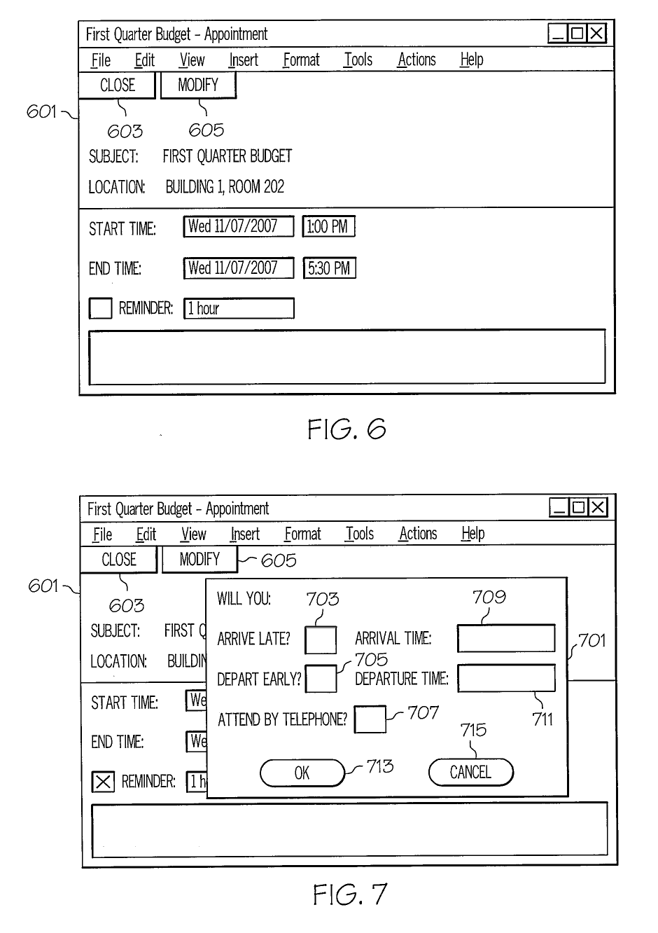

FIG. 6 illustrates a calendar item 601 according to the present invention. Calendar item 601 provides information about an event that has been scheduled on an attendee's calendar. The attendee can view details of a scheduled event with calendar item 601. Calendar item 601 includes a close button 603 that enables a user to close calendar item 601. Calendar item 601 also includes a Modify button 605 that enables an attendee to modify the terms of his or her attendance at the event of calendar item 601. As shown in FIG. 7, actuation of Modify button 605 causes the display of an attendance modification dialog 701 that is similar to attendance modification dialog 501 of FIG. 5. Attendance modification dialog 701 includes an Arrive late checkbox 703, a Depart early checkbox 705, and an Attend by telephone checkbox 707. As those skilled in the art will recognize, a system according to the present invention my include logic or intelligence whereby if the event is a teleconference, Web conference, or the like, acceptance dialog 701 will not include Attend by telephone checkbox 707. Attendance modification dialog 701 includes an arrival time entry field 709 and a departure time entry field 711. The attendee may enter his or her anticipated arrival time or departure time into entry field 709 and 711, respectively. After the attendee has completed attendance modification dialog 701, the attendee can register modified terms of attendance by actuating an OK button 713. Attendance modification dialog 701 also includes a Cancel button 715 that allows the attendee to return to calendar item 601 of FIG. 6 without modifying his or her terms of attendance.

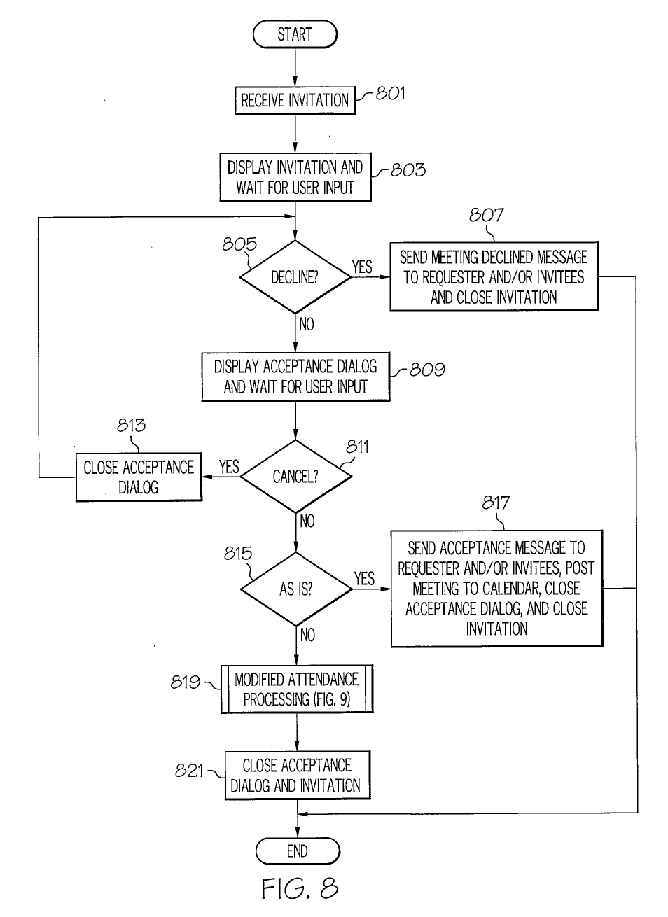

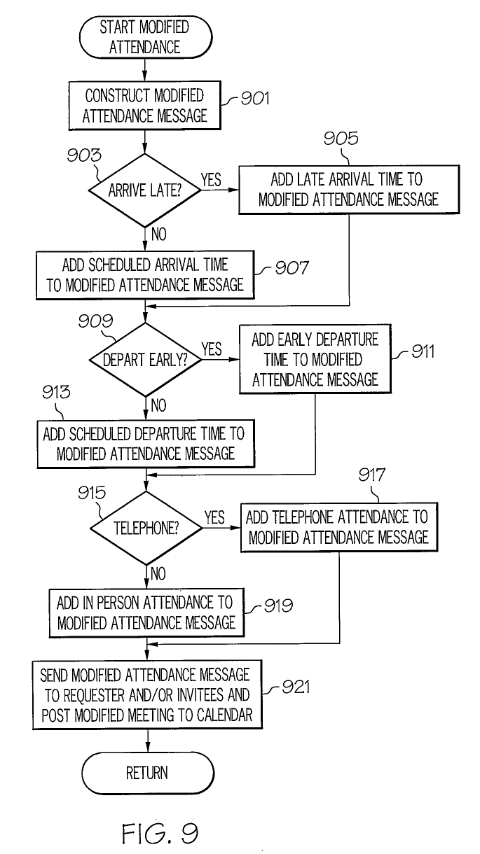

FIG. 8 is a high-level flowchart of invitation processing by an invitee's computer according to an embodiment of the present invention. The invitee receives an invitation, as indicated at block 801. The invitee's computer displays the invitation of the type illustrated in FIG. 2 and waits for user input at block 803. If, as determined at decision block 805, the invitee declines the invitation, the invitee's computer sends a meeting declined message to the requester, and optionally to the other invitees, and closes the invitation, as indicated at block 807. If, as determined at decision block 805, the invitee does not decline the invitation, the invitee's computer displays an acceptance dialog of the type illustrated in FIG. 3 and waits for user input, as indicated at block 809. If as determined at decision block 811, the invitee cancels the acceptance dialog, the invitee's computer closes the acceptance dialog, as indicated at block 813, and returns to decision block 805. If, as determined at decision block 811, the user input is not cancel, the invitee's computer determines, at decision block 815, if the user has selected as is. If so, the invitee's computer sends an acceptance message to the requester, and optionally to the other invitees, posts the meeting to the invitee's calendar, closes the acceptance dialog, and closes the invitation, all as indicated at block 817. If, as determined at decision block 815, the invitee does not accept the invitation as is, the invitee's computer performs modified attendance processing, as indicated generally at block 819 and as shown in detail in FIG. 9. After performing modified attendance processing at block 819, the invitee's computer closes the acceptance dialog and invitation, at block 821, and processing ends.

FIG. 9 illustrates modified attendance processing according to an embodiment of the present invention. The system constructs a modified attendance message, at block 901. A modified attendance message notifies the requester of an event, and optionally other invitees to the event, that an invitee or attendee has modified the terms of his or her attendance. The system determines, at decision block 903, if the invitee or attendee will arrive late at the event. If so, the system adds the late arrival time to the modified attendance message, at block 905. If not, the system adds the scheduled arrival time to the modified attendance message, at block 907. Then, the system determines, at decision block 909, if the attendee or invitee will depart early from the event. If so, the system adds the early departure time to the modified attendance message, at block 911. If not, the system adds the scheduled departure time to the modified attendance message, at block 913. Then, the system determines, at decision block 915, if the invitee or attendee will attend by telephone. If so, the system adds telephone attendance to the modified attendance message, at block 917. If not, the system adds in person attendance to the modified attendance message, at block 919. Then, the system sends the modified attendance message to the requester, and optionally to the other invitees, and posts the modified meeting to the invitee or attendee's calendar, as indicated at block 921. The system may mark the attendee's calendar as being occupied only between the late arrival and/or early departure time, thereby leaving as free time any periods of the event before the late arrival time or after the early departure time.

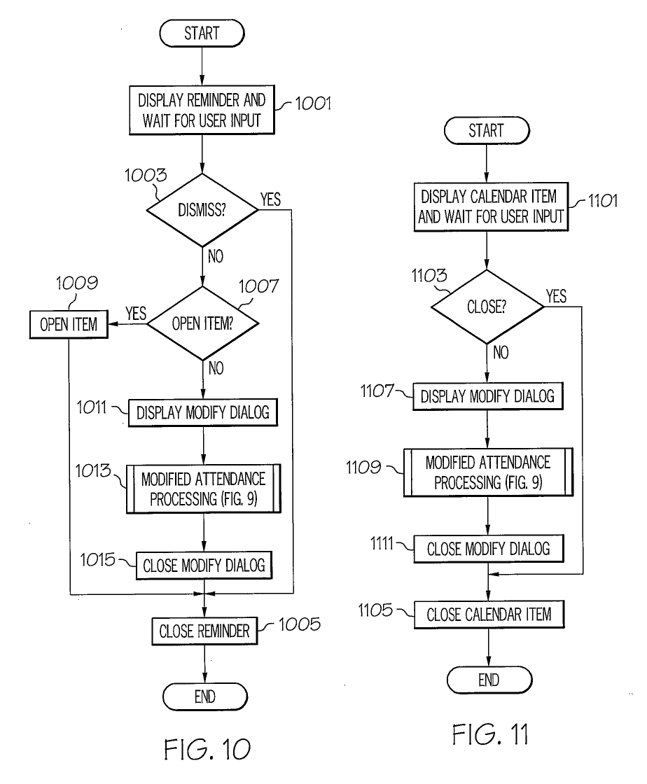

FIG. 10 illustrates reminder processing according to an embodiment of the present invention. The system displays reminder of the type illustrated in FIG. 4 and waits for user input, as indicated at block 1001. Then, the system determines, at decision block 1003 if the user input is Dismiss. If so, the system closes the reminder, at block 1005, and processing ends. If, as determined at decision block 1003, the user input is not Dismiss, the system tests, at decision block 1007, if the user input is Open Item. If so, the system opens a calendar item, of the type illustrated for example in FIG. 6, underlying the reminder, at block 1009, and closes the reminder, at block 1005. If, as determined at decision block 1007, the user input is not Open Item, the system displays a modify dialog of the type illustrated in FIG. 5, as indicated at block 1011. Then, the system performs modified attendance processing, as indicated at block 1013 and as described in detail with reference to FIG. 9. After performing modified attendance processing, the system closes the modify dialog, at block 1015, closes the reminder, at block 1005, and processing ends.

FIG. 11 illustrates calendar item processing according to an embodiment of the present invention. The system displays a calendar item of the type illustrated in FIG. 6 and waits for user input, at block 1101. If as determined at decision block 1103, the user input is close, the system closes the calendar item, at block 1105, and processing ends. If the user input is not close, then the system displays a modify dialog of the type illustrated in FIG. 7, as indicated at block 1107. Then, the system performs modified attendance processing, as indicated generally at block 1109 and as described in detail with reference to FIG. 9. After performing modified attendance processing, the system closes the modify dialog, at block 1111. Then, the system closes the calendar item, at block 1105, and processing ends.

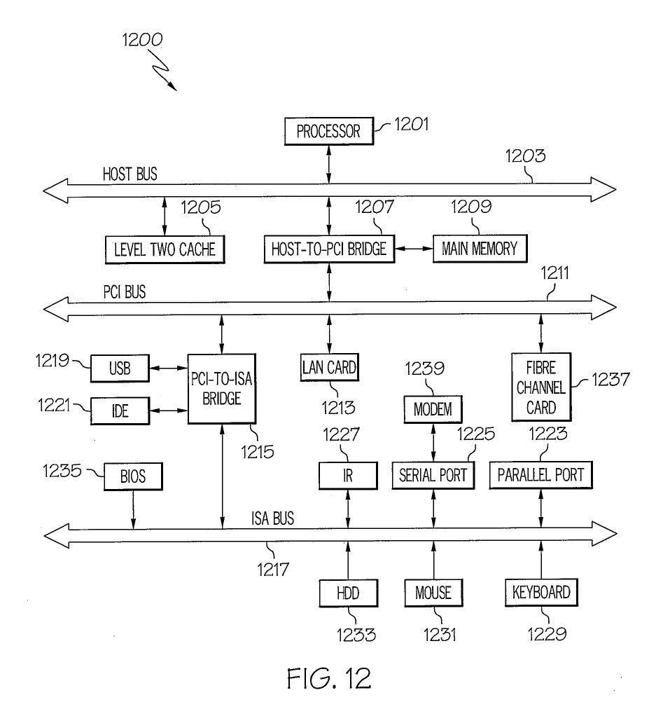

Referring now to FIG. 12, there is illustrated a block diagram of a generic information handling system 1200 capable of performing the server and client operations described herein. Computer system 1200 includes processor 1201 which is coupled to host bus 1203. Processor 1201 preferably includes an onboard cache memory. A level two (L2) cache memory 1205 is also coupled to host bus 1203. A Host-to-PCI bridge 1207 is coupled to host bus 1203. Host-to-PCI bridge 1207, which is coupled to main memory 1209, includes its own cache memory and main memory control functions. Host-to-PCI bridge 1207 provides bus control to handle transfers among a PCI bus 1211, processor 1201, L2 cache 1205, main memory 1209, and host bus 1203. PCI bus 1211 provides an interface for a variety of devices including, for example, a local area network (LAN) card 1213, a PCI-to-ISA bridge 1215, which provides bus control to handle transfers between PCI bus 1211 and an ISA bus 1217, a universal serial bus (USB) 1219, and an IDE device 1221. PCI-to-ISA bridge 1215 also includes onboard power management functionality. PCI-to-ISA bridge 1215 can include other functional elements not shown, such as a real-time clock (RTC), DMA control, interrupt support, and system management bus support.

Peripheral devices and input/output (I/O) devices can be attached to various interfaces or ports coupled to ISA bus 1217. Such interfaces or ports may include a parallel port 1223, a serial port 1225, an infrared (IR) interface 1227, a keyboard interface 1229, a mouse interface 1231, and a hard disk drive (HDD) 1233.

A BIOS 1235 is coupled to ISA bus 1217. BIOS 1235 incorporates the necessary processor executable code for a variety of low-level system functions and system boot functions. BIOS 1235 can be stored in any computer readable medium, including magnetic storage media, optical storage media, flash memory, random access memory, read only memory, and communications media conveying signals encoding the instructions (e.g., signals from a network). In order to couple computer system 1200 to another computer system to copy files or send and receive messages over a network, LAN card 1213 may be coupled to PCI bus 1211. Similarly, a Fibre Channel 1237 card may be coupled to PCI bus 1213. Additionally, a modem 1239 may be coupled to ISA bus 1217 through serial port 1225 to support dial-up connections.

While the computer system described in FIG. 12 is capable of executing the invention described herein, the illustrated system is simply one example of a computer system. Those skilled in the art will appreciate that many other computer system designs are capable of performing the invention described herein.

One of the preferred implementations of the invention is an application, namely, a set of instructions (program code) in a code module that may, for example, be in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method of scheduling an electronic calendar event, which comprises the computer implemented steps of:
permitting an attendee of said calendar event to modify terms of attendance of said calendar event for said attendee; and,
in response to a modification of said terms of attendance, notifying a requester of said calendar event of said modification of terms of attendance.

2. The method as claimed in claim 1, wherein said terms of attendance include:
an event start time and an event end time for said attendee.

3. The method as claimed in claim 1, wherein permitting said attended to modify said terms of attendance includes:
displaying to said attendee an attendance modification dialog.

4. The method as claimed in claim 3, wherein said modification dialog includes:
a late arrival field; and,
an early departure field.

5. The method as claimed in claim 4, wherein said modification dialog further includes:
a telephone attendance control.

6. The method as claimed in claim 1, further comprising:
in response to a modification of said terms of attendance, notifying other invitees to said calendar event of said modification of terms of attendance.

7. The method as claimed in claim 1, wherein permitting said attendee to modify said terms of attendance includes:
displaying to said attendee an event invitation, said event invitation including an acceptance control; and,
in response to actuation of said acceptance control, displaying to said attendee an acceptance dialog.

8. The method as claimed in claim 7, wherein said acceptance dialog includes:
a late arrival option; and,
an early departure option.

9. The method as claimed in claim 7, wherein said acceptance dialog includes:
a telephone attendance option.

10. The method as claimed in claim 9, including;
in response to selection of an option, notifying a sender of said invitation of a modification of terms of acceptance by said attendee.

11. The method as claimed in claim 1, wherein permitting said attendee to modify said terms of attendance includes:
displaying to said attendee an event reminder, said event reminder including a modify control; and,
in response to actuation of said modify control, displaying to said attendee an attendance modification dialog.

12. The method as claimed in claim 11, wherein said attendance modification dialog includes:
a late arrival option; and,
an early departure option.

13. The method as claimed in claim 11, wherein said acceptance dialog includes:
a telephone attendance option.

14. The method as claimed in claim 12, including;
in response to selection of an option, notifying a requester of said event a modification of attendance by said attendee.

15. The method as claimed in claim 1, wherein permitting said attendee to modify said terms of attendance includes:
displaying to said attendee a calendar item for said event, said calendar item including a modify control; and,
in response to actuation of said modify control, displaying to said attendee an attendance modification dialog.

16. The method as claimed in claim 15, wherein said attendance modification dialog includes:
a late arrival option; and,
an early departure option.

17. The method as claimed in claim 15, wherein said acceptance dialog includes:
a telephone attendance option.

18. The method as claimed in claim 16, including;
in response to selection of an option, notifying a requester of said event of a modification of terms of attendance by said attendee.

19. An electronic calendar system, which comprises:
a calendar and email client, said calendar and email client being configured to display a modification dialog, said modification dialog being configured to present options for modifying terms of attendance at an event, and said calendar client being configured to notify automatically an event requester of a modification of terms of attendance at said event.

20. An article of manufacture for implementing a method of modifying terms of attendance at calendar events, which comprises:
a computer readable medium having computer readable code thereon, said compute readable code comprising:
instructions for displaying an attendance modification dialog; and,
instructions for notifying an event requester of a modification of terms of attendance at said event.
